(19) United States
(12) Patent Application Publication
(10) Pub. No.: US 2022/0417119 A1
(43) Pub. Date: Dec. 29, 2022

(54) CORRELATIVE RISK MANAGEMENT FOR MESH NETWORK DEVICES

(71) Applicant: International Business Machines Corporation, Armonk, NY (US)

(72) Inventors: Thomas Jefferson Sandridge, Tampa, FL (US); Jacob Thomas Covell, New York, NY (US); Clement Decrop, Arlington, VA (US); Sarah Bootman, Astoria, NY (US)

(21) Appl. No.: 17/361,545

(22) Filed: Jun. 29, 2021

(51) Int. Cl. H04L 12/26; H04L 29/08

(52) U.S. Cl. CPC H04L 43/04; H04L 67/12; H04W 84/18

(57) ABSTRACT

A network of Internet of Things (IoT) devices can leverage sensor data from the IoT devices to detect that a device has been activated, determine whether the activation was intentional, and, if it were not, issue commands to deactivate the device. The network can learn over time to correlate trends in sensor data with activations of devices.

### BACKGROUND

The systems and methods of the present disclosure relate to mesh networks and Internet of Things (IoT) devices.

The “Internet of Things” (IoT) refers to the recent trend of adding network functionality to devices, many of which may not typically have been associated with connectivity. For example, smart home devices such as smart ovens, voice assistants, smart thermostats, and the like are all examples of “IoT devices.” IoT devices often can work together and communicate with one another, enabling users to, for example, turn their oven on to a set temperature and turn the lights on via an application on the user's mobile device (notably without the user even being present at the house). Other IoT applications include industrial settings such as factories, where different manufacturing components (assembly line robots, conveyer belt systems, smelters, etc.) can communicate with one another in order to improve efficiency.

Mesh networking refers to a style (or “topology”) of networking in which multiple nodes are interconnected. In instances where every node are connected to all other nodes, the mesh is described as “fully connected.” Otherwise, the mesh is “partially connected.” More traditional networks may take a “star” or “tree” topology, having a central “hub” node.

### SUMMARY

Some embodiments of the present disclosure can be illustrated as a method. The method comprises monitoring sensor data. The method also comprises comparing the sensor data to an activation profile in a knowledgebase. The method also comprises detecting (based on the comparison) an activation of a first device in a network. The method also comprises calculating an activation confidence score of the activation based on a use profile in the knowledgebase. The method also comprises calculating a risk of the activation based on a device profile in the knowledgebase. The method also comprises calculating a confidence-adjusted risk score based on the activation confidence score and on the risk. The method also comprises determining that the confidence-adjusted risk score is above a risk threshold. The method also comprises issuing, by a second device in the network, a command to the first device in response to determining that the confidence-adjusted risk score is above the risk threshold.

Some embodiments of the present disclosure can also be illustrated as a computer program product comprising a computer readable storage medium having program instructions embodied therewith, the program instructions executable by a computer to cause the computer to perform the method discussed above.

Some embodiments of the present disclosure can be illustrated as a system. The system may comprise memory and a central processing unit (CPU). The CPU may be configured to execute instructions to perform the method discussed above.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Features and advantages of various embodiments of the claimed subject matter will become apparent as the following Detailed Description proceeds, and upon reference to the drawings, in which like numerals indicate like parts, and in which:

FIG. 1 is a high-level method of mesh network IoT device monitoring, consistent with several embodiments of the present disclosure.

FIG. 2 is a diagram of an example mesh network of IoT devices, consistent with several embodiments of the present disclosure.

FIG. 3 is a method of issuing commands via multiple devices in a mesh network, consistent with several embodiments of the present disclosure.

FIG. 4 is a diagram of an example knowledgebase including entries for multiple devices in an IoT mesh network, consistent with several embodiments of the present disclosure.

FIG. 5 is a method 500 for initial configuration and training of a mesh network implementing correlative risk management, consistent with several embodiments of the present disclosure.

FIG. 6 illustrates a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to systems and methods to automatically detect inadvertently activated appliances and deactivate them. More particular aspects relate to detecting a device activation, calculating a risk-adjusted confidence score of the activation, and taking action based on the risk-adjusted confidence score.

Networks of IoT devices such as smart home appliances are becoming increasingly common, often providing added convenience and increased accessibility. For example, users may be able to set their thermostat to turn their air conditioning on (or off) without being present at their home. Similarly, a user may be enabled to turn a smart oven on and set it to a specified temperature to reheat before the user arrives. However, this can also result in risk. For example, accidentally activating a smart oven without realizing it can result in an increased risk of fire, particularly if a user is not present in the house to notice the increased heat (or eventual smoke). As another example, inadvertently setting a thermostat to a low temperature (e.g., 60 degrees Fahrenheit) when a user is not home may result in a substantial waste of energy cooling an empty house. Systems and methods consistent with the present disclosure can mitigate these and similar risks by leveraging a network of IoT devices in a location.

As an overview, a system consistent with the present disclosure can monitor sensor data recorded by different IoT devices in a smart building to detect that a device has been activated, determine a confidence that the activation was intentional, a risk associated with the activation, and a risk-adjusted confidence in the activation. As an illustrative example, a system may be able to detect, via a thermometer installed in a microwave, that a temperature in a smart home's kitchen is rising. This information, combined with power consumption measured by a smart electric meter, can suggest that an oven has been activated. Notably, if the oven is a “smart oven” and is part of the IoT network, the oven itself may simply indicate that it has been activated. However, if the oven is not part of the network, then the activation may need to be discovered by the network.

The system may determine, based on a knowledge base detailing previous activations of the oven, that this detected activation is likely unintentional (e.g., because the activation is at 10:00 AM, when the user is typically away from home at work for at least another 8 hours as indicated by the user's calendar). Further, the system may determine that the oven is a particularly high-risk activation, being associated with an increased risk of fire. In response to these determinations, a risk-adjusted confidence that the oven should be deactivated may be relatively high. In response, one or more devices may send a termination signal (a “kill command”) to deactivate the oven. Further, a message may be sent to the user notifying the user that the oven was detected to have activated and was subsequently deactivated. The user may be given the option to override the deactivation (for example, if the user actually did intend to activate the oven). Based on the user's response (or lack thereof), the knowledge base can be updated, such as to reflect that the activation was indeed unintentional.

In some instances, the knowledge base may include information about each device in the system. For example, the knowledge base may include, for each device, a device profile, an activation profile, and a use profile.

A “device profile” may describe aspects of the device itself such as, for example, a make and model of the device, capabilities of the device, a location (such as in a smart home) of the device, sensors that the device includes, etc. The device profile can be set by a manufacturer of the device and/or configured by a user.

An “activation profile” may describe circumstances associated with the device being activated. For example, an activation profile may indicate that a microwave oven makes an audible beep on activation followed by a hum, and that a light is active while the microwave oven is active. The activation profile may also indicate that the microwave oven is associated with a ˜1 kW increase in power consumption as well as some electromagnetic radiation such as radio frequency (RF) noise. In essence, any detectable indicators that the microwave oven has been activated might be represented in the activation profile.

A “use profile” may describe usage patterns of the device. For example, the use profile may include a historical database describing circumstances of each instance the device has been used (e.g., time, date, duration, etc.). This information may be summarized in detected patterns; for example, a use profile might indicate that a microwave oven is typically used for 3 minutes on Tuesday evenings, from anywhere between 6 PM and 8 PM. Thus, if the microwave oven is detected to be activated at 3 AM on a Thursday, the use profile may support a conclusion that the activation is not intentional.

The devices on the mesh network can work collectively as a system to determine a course of action. Each device on the network may include one or more sensors. Each sensor may have a weight reflecting how reliable the sensor's data is in detecting a device activation. These weights can further be specific to the device being activated. As a simple explanation, the weights reflect whether or not the device's sensors “can tell” whether a given device has been activated. For example, a thermostat may have a thermometer and a microphone. Activation of a microwave oven in an adjacent room may not impact local temperature around the thermostat. Therefore, the thermometer may have a relatively low weight associated with activation of the microwave oven, indicating that the thermometer is a relatively poor indicator of whether the microwave oven has been activated. On the other hand, the microwave oven may emit a distinctive beep upon being activated, which the thermostat's microphone may be capable of detecting. Thus, the thermostat's microphone may have a relatively high weight associated with activation of the microwave oven, meaning that the microphone is a relatively good indicator of whether the microwave oven has been activated.

Applying this concept to additional devices in the mesh network can result in several sources of weighted sensor data, improving confidence in determinations of whether a device has been activated. For example, a smart house may include the smart thermostat including the thermometer and microphone described above, along with a smart refrigerator including both its own thermometer and a camera. The smart house may also include a smart energy meter. The smart thermostat, refrigerator, and energy meter may communicate in a mesh network, allowing sharing of sensor data. When a microwave oven in the smart house is activated, the thermostat's microphone may detect a signature beep, while the energy meter may detect a 1 kW increase in power consumption. Further, the refrigerator camera may detect an increase in light due to a light from the microwave oven. However, the refrigerator and thermostat's thermometers may not register any noticeable temperature change. This arrangement can be relatively robust at detecting activation of the microwave oven, as the multiple reliable sensor feeds provide redundancy. For example, the refrigerator camera's lens may be dirty to the point where it can no longer detect whether the microwave oven's light is on (and therefore whether the microwave oven has been activated). However, activation of the microwave oven can still be detected by the system via the thermostat's microphone and the energy meter.

Systems and methods consistent with the present disclosure can be particularly advantageous in mitigating safety risks of IoT devices. For example, a user may utilize IoT functionality to activate a conventional oven and set the oven to heat to a specific temperature, even if the user is not present at the home. However, this capability also includes a risk that the oven is activated unintentionally, which, if left unchecked, risks starting a dangerous fire. Thus, in addition to detecting activation of a device, systems and methods consistent with the present disclosure also enable determining a confidence of whether a detected activation is intentional, as well as taking steps to mitigate high-risk situations.

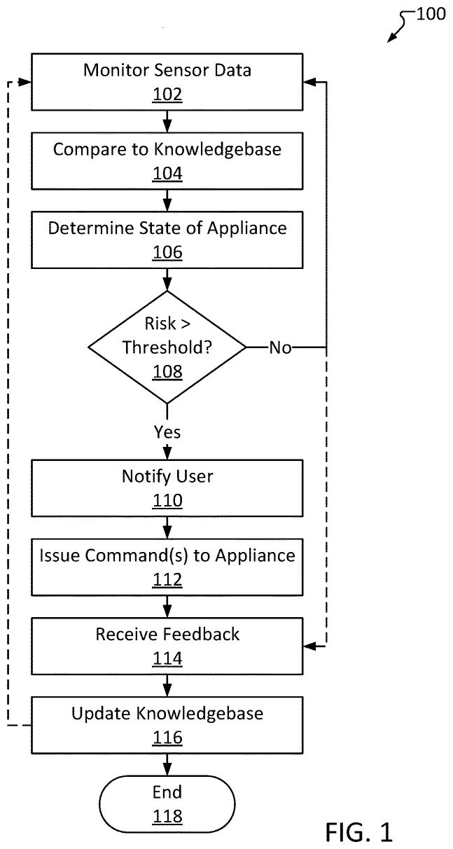

FIG. 1 is a high-level method 100 of mesh network IoT device monitoring, consistent with several embodiments of the present disclosure. Method 100 comprises monitoring sensor data at operation 102. Operation 102 may include, for example, receiving temperature data from a thermometer, receiving sound data from a microphone, etc. The sensor data received at operation 102 may also include data describing a source of the sensor data. For example, operation 102 may include receiving multiple temperature readouts from different thermometers, such as a first temperature from a smart refrigerator's thermometer, a second temperature from a smart light bulb's thermometer, etc.

Method 100 further comprises comparing the sensor data to a knowledge base at operation 104. Operation 104 may include, for example, comparing the sensor data being monitored via operation 102 to activation profiles of known devices. As an example, a refrigerator's thermometer may detect a temperature increase while a light bulb's thermometer may not detect a temperature change. Further, a smart energy meter may detect an increase in power consumption. A conventional oven's activation profile may describe conditions associated with activation of the oven, such as “temperature increase at refrigerator,” “no temperature change at light bulb,” and “increase in energy consumption.”

Method 100 further comprises determining a state of a device at operation 106. Operation 106 may include detecting that a device has been activated based on the sensor data from operation 102 and the comparison at operation 104. For example, operation 106 may include cross referencing the sensor data and the comparison, identifying a match based on the cross referencing, and identifying a state of an appliance based on the detected match. Continuing with the conventional oven example, as all of the conditions described in the oven's activation profile have been met, operation 106 may include determining that the conventional oven has been activated. In some instances, a device being activated may be connected to the IoT network, in which case the activation can be confirmed by the device itself.

Method 100 further comprises determining whether an adjusted risk rating associated with the detected state is above a risk threshold at operation 108. Operation 108 may include, for example, determining a confidence that an activation was intentional, as well as an overall risk associated with a device being activated. The overall risk can be an amalgamation of multiple categories of risk. For example, a device may be associated with a risk of fire, rated from 0 (device cannot cause fire) to 4 (device likely to cause fire without user intervention). The device may also have a power risk, represented by a category of power consumption associated with the device (e.g., 100 W, 5 W, 2 kW, etc.). In some instances, a device being activated unintentionally may comprise a security risk as well, such as a garage door, a lock, etc.

For example, upon detecting that an oven has been activated, a system performing method 100 may compare a time of the oven's activation to a use profile stored in the knowledge base. The use profile may indicate typical times where detected activation of the oven is expected. If the time of the detected activation differs from typical times, the confidence that the activation is intentional may be relatively low. Other factors include whether a user is present, nature of the activation (if known), events in a user's house, etc. For example, if a conventional oven is only capable of being activated “manually” (e.g., by pressing a button on the oven itself, rather than remote activation enabled via IoT integration) and no users are detected as present in the house, the activation may be deemed unintentional (for example, a cat may have accidentally pressed the button). If, on the other hand, the user typically activates the device at around the current time and the user is at home, the activation may be deemed to be intentional.

Further, the system may check a device profile associated with the device to determine possible risks. For example, the device profile may include a risk of fire, injury, energy waste, etc. This information can be used as a weight for the confidence value, resulting in a risk-adjusted confidence rating (or vice versa; in some instances, the confidence can be used as a weight for the risk value, resulting in a confidence-adjusted risk rating). If the activation is likely unintentional or is relatively dangerous, this may constitute a safety concern (108 “Yes”). If the activation is low-risk and the activation appears to have been intentional, the overall risk may be relatively low (108 “No”). The thresholds can vary depending upon use case and can be configured by the user. Further, in some instances, the thresholds can describe the weighting relationship between risk and confidence. For example, in some instances, a user may indicate that the system is to disregard any activity that it determines is likely intentional (e.g., confidence >95%), regardless of risk. As an additional example, in some instances, a user may indicate that the system is to intervene in any device activity that is particularly dangerous (e.g., having a high risk of fire), even if the activation is deemed intentional. In some instances, a user may set different thresholds for different devices. For example, a user may modify a knowledge base to indicate, via a device profile, risk settings and behaviors (e.g., an oven may be set to “alert user if activation confidence <95%,” while a television may be set to “alert user if activation confidence <5%”).

If the risk is above the threshold for the given device (108 “Yes”), method 100 further comprises notifying a user at operation 110. Operation 110 may include, for example, pushing a notification to a user's mobile device, emitting a sound in the home (possibly subject to detecting that the user is present), etc. In some instances, operation 110 can vary depending upon user settings; for example, a user may indicate that, if the high-risk activity detected is an unintentional activation of a television, the system should deactivate the television without notifying the user (e.g., operation 110 may be skipped and method 100 may proceed to operation 112). In some instances, operation 110 may include sending a prompt to a user, requesting input on how to address the detected situation. As an example, operation 110 may include sending a text message to a user's mobile phone reading “We detected that your oven has been turned on. Did you mean to do this? Reply “No” and we will deactivate your oven for you.” In other instances, the message may indicate a default behavior (e.g., “if we don't receive a reply in 10 minutes, we will deactivate the oven automatically for your safety.”) In some instances, operation 110 may notify the user of an action already taken (e.g., “We noticed that your oven was turned on by accident. We went ahead and shut it off for you. Please check your app for details.”).

Method 100 further comprises issuing a command to the device at operation 112. Operation 112 may include, for example, sending a “kill command” to a smart appliance that was detected to have been activated. Similar to operation 110, operation 112 can vary depending upon user preferences. For example, in some instances, operation 112 may include turning a device off via a kill command. For example, operation 112 may include sending a command to a smart oven to cause the oven to turn off. In some instances, operation 112 may include modifying the device's behavior without deactivating it. For example, operation 112 may include setting a television's brightness level to a minimum (so as to conserve energy without turning the television off entirely). As another example, if the system detects that the oven has been activated and set to 450° F. but that the activation was possibly unintentional (e.g., confidence=60%), the system may notify the user and request confirmation that the activation was intentional. In the meantime, due to the high risk of fire associated with the oven, the system may, via operation 112, set the temperature of the oven to a minimum nonzero amount (e.g., change the 450° F. goal temperature to a preheat temperature of 135° F.) until a user input is received confirming that the setting was intentional.

Method 100 further comprises receiving feedback at operation 114. Operation 114 may include, for example, receiving an input from a user in response to the notification sent at operation 110. For example, a user may indicate whether the detected activation was actually intentional or not in response to a message sent to the user's mobile device. However, operation 112 does not necessarily require receiving a user response to a notification sent via operation 110. For example, in some instances, operation 114 may include detecting the user activating the device again within a short time period after the system deactivated it via operation 112. As an example, the system may detect that an oven was turned on and determine that the oven was likely turned on by accident. In response to this, the system may deactivate the oven and notify the user that the oven was deactivated, along with requesting feedback from the user regarding whether the user actually intended to activate the oven. However, the user may not reply to the feedback request. In such an instance, operation 114 may include detecting that the oven is activated again, and that the second activation is likely intentional. In some instances, operation 114 may include inferring, based on a lack of user response and a lack of detecting the device being activated again, that the initial activation was likely unintentional. As an example, an oven might only be activatable via an on button (as in, the oven may not support remote activation). A nearby refrigerator may have a video camera that can see the oven. If the oven is activated, the camera feed from the refrigerator may be checked to determine whether a user was present in a vicinity of the oven when the oven was activated. If not, a user may be notified of a possible short circuit activating the oven.

In some instances, the system performing method 100 may issue a further command based on results of operation 114. For example, the system may change an oven's setting from 450° F. to 135° F. while awaiting a user's feedback. The user may then reply to indicate that the activation was intentional, in which case the system may change the oven's setting from 135° F. back to 450° F. Similarly, if the user replies indicating that the activation was unintentional, the system may fully deactivate the oven.

Method 100 further comprises updating the knowledgebase at operation 116. Operation 116 may include, for example, creating an entry in the knowledgebase regarding the detected activation, including the sensor data considered at operation 102, the notification sent at operation 110, the commands issued at operation 112, as well as the feedback received at operation 114. As an example, operation 116 may include adjusting a use profile for the device to reflect whether the detected sensor data actually correlated to an intentional activation of the device, as well as noting a time and date, etc. This way, the system can continue to learn over time. For example, if the user begins turning an oven on at 4 PM on Saturdays, the system may initially determine that the first activation is unintentional, as this may not align with an expected time to turn the oven on. However, after receiving feedback via operation 114, the system may update the knowledgebase via operation 116 to reflect that the activation of the oven at 4 PM on Saturday is intentional. This way, if the user continues to use the oven in this manner, the system may eventually determine that future activations are likely intentional. This concept can be expanded to account for other circumstantial data. For example, the oven may be more likely to be used prior to a party scheduled in the user's calendar events or on a holiday associated with baking (e.g., Thanksgiving). As another example, a smart outdoor grill may be less likely to be used if current weather is rainy. Further, an oven activated shortly after a user accesses a recipe website including a recipe calling for baking in an oven may be more likely to be intentional, etc.

With the updated knowledgebase, method 100 may end at 118. However, the system may continue to monitor sensor data via operation 102 (depicted in FIG. 1 via a dashed line), indicating that the system can continuously monitor for various device activations, even while learning.

If the risk of a detected activation is below the threshold (108 “No”), method 100 may return to monitoring at operation 102. However, in some instances, feedback may still be received via operation 114, particularly in the case of a “false negative.” For example, a system performing method 100 may provide a user with an interface depicting current detected status of every known device in a smart home, enabling a user to make corrections. As an example, an oven may be detected to be activated at operation 106, but the activation may be considered intentional, and thus the risk may be below the threshold at operation 108. This may be shown in a user interface available to the user via, for example, a smartphone application. The user may notice that the oven is detected to be on and that the activation was deemed intentional, and the user may indicate that this is incorrect (either the oven isn't on, or the user did not intend to activate the oven). In such an instance, method 100 may proceed from 108 “No” to operations 114 and 116 (as indicated by the dashed line). This way, the system can learn and develop the knowledgebase even when it incorrectly determines that an appliance is on/that an activation was intentional. In some instances, the feedback received via operation 114 may simply be detecting the user deactivating the device (e.g., oven) without using it.

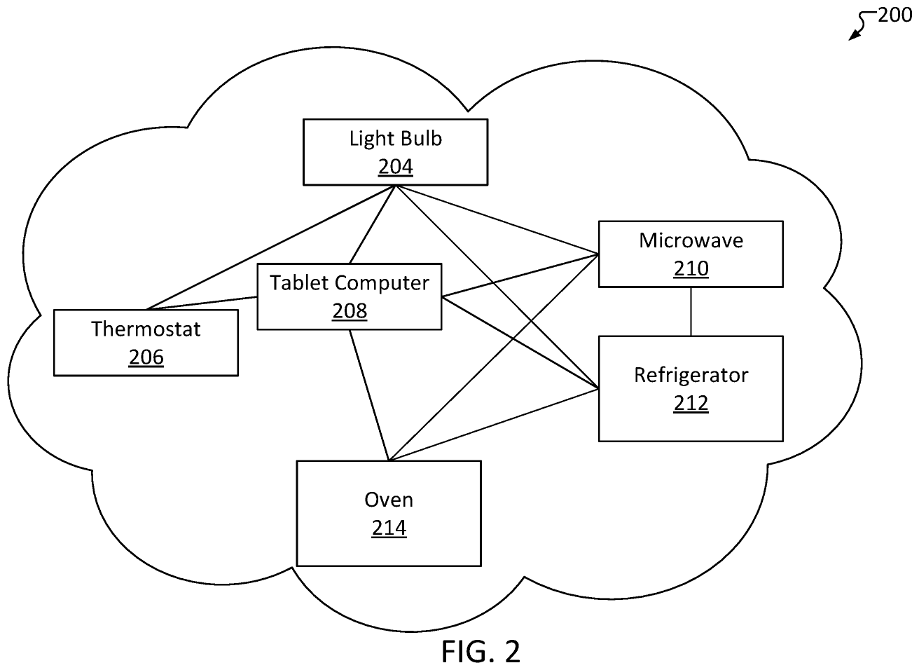

FIG. 2 is a diagram of an example mesh network 200 of IoT devices, consistent with several embodiments of the present disclosure. Network 200 includes a smart light bulb 204, a smart microwave oven 210, a smart thermostat 206, a tablet computer 208, a smart refrigerator 212, and a smart conventional oven 214 (“conventional” referring to the nature of the oven, e.g., as opposed to a microwave oven). As shown in FIG. 2, network 200 is a partially connected network. While each device (or “node”) in the network is connected to at least two other devices, not all devices are connected to all other devices. For example, thermostat 206 is connected to light bulb 204 and tablet computer 208, but thermostat 206 is not connected to oven 214. Regardless, devices in network 200 can still communicate via one another. For example, thermostat 206 may be capable of transmitting a message to tablet computer 208 with instructions to pass the message to microwave 210 (effectively using tablet computer 208 as a relay). Each device in network 200 may include one or more sensors (not shown in FIG. 2). For example, thermostat 206 may include a microphone and a thermometer, tablet computer 208 may include a camera and microphone, oven 214 may include a thermometer, etc. The sensor data from each device can be shared amongst other devices on network 200.

Devices in network 200 may be configured to enable multi-channel kill switch safety override features. For example, microwave oven 210 may be configured to deactivate upon receipt of a kill switch command from light bulb 204 (or from oven 214, or from any other device in network 200). This way, any device in network 200 may be enabled to deactivate any other device in network 200.

In some instances, some devices in network 200 may have limited privileges relative to other devices; for example, light bulb 204 may not be capable of issuing kill switch commands to microwave oven 210. This can be enabled to provide for possibilities where a device in network 200 frequently issues commands that are deemed erroneous (e.g., if light bulb 204 repeatedly issues kill commands to microwave oven 210 that are learned to be incorrect).

In some instances, the computing resources and sensor data of devices in network 200 may be pooled to enable network 200 to operate in tandem as a single unit, similar to distributed computing implementations. For example, each device in network 200 may send its sensor data to other devices in network 200, such that all devices may have access to all sensor data. The devices may then utilize this sensor data, in conjunction with a knowledgebase (which may be similarly shared/distributed amongst network 200), to collectively determine whether a given device has been activated.

In some instances, rather than share sensor data amongst one another, each device in network 200 may utilize its own sensor data to make a given determination. For example, light bulb 204 may make a first determination as to whether oven 214 has been activated, while microwave 210 may make a second determination based on its own sensors as to whether oven 214 has been activated. Over time, each device may be weighted based on accuracy of its determinations. For example, light bulb 204 may be a poor predictor of whether the oven is actually on, while microwave 210 may be a relatively strong predictor. Thus, when each device of network 200 makes a determination, their determinations may be aggregated based on their given weights, and a consensus can be reached based on the results.

In some situations, a first device of network 200 may issue a command to a target device of network 200, but the command may not be executed. For example, microwave oven 210 could issue a shutdown command to oven 214, but oven 214 may remain activated. This could occur for a variety of reasons. For example, a connection between microwave oven 210 and oven 214 may have a relatively poor connection strength (particularly if the two devices are situated relatively far from one another). As another example, an unknown error may have occurred in microwave oven 210, preventing it from functioning properly (e.g., software executing on microwave oven 210 may have crashed or become corrupted). While this may be relatively unlikely, in view of the possibility of a command not being received, devices of network 200 may continue to monitor for signs of the command being executed. For example, if oven 214 is instructed to shut down after being active for an hour, devices of network 200 including thermometers may continue to monitor their local temperatures, anticipating a gradual drop in temperature (at devices near oven 214, at least). If sensor data does not coincide with anticipated results, an additional device of network 200 may be selected to transmit the command again. In some instances, rather than (or in addition to) monitoring sensor data, the devices of network 200 may expect an acknowledgement from the target device. For example, oven 214 may be expected to reply to a shutdown command to acknowledge receipt of the command. However, in consideration of the possibility that the target device is unable to transmit the command (for example, if the oven's software has become corrupted), the devices of network 200 may still monitor for proof of execution of the command.

In some instances, devices in network 200 may be configured to be able to cut power to oven 214 as a last resort (e.g., if oven 214 is not responding to shutdown commands). Cutting power may also be utilized if oven 214 is not a part of network 200, as in such cases other devices in network 200 may be unable to transmit a shutdown command to oven 214. In some instances, a user may determine whether devices in network 200 have permission to cut power to other devices.

In some instances, rather than a mesh network, network 200 may be a centralized network including a master controller (for example, tablet computer 208 may function as a master controller), which may receive sensor data from each of the devices in network 200, store the knowledgebase, and make decisions regarding activations/deactivations, notifying users, etc. In some instances, a master controller may be a remote server (not shown in FIG. 2).

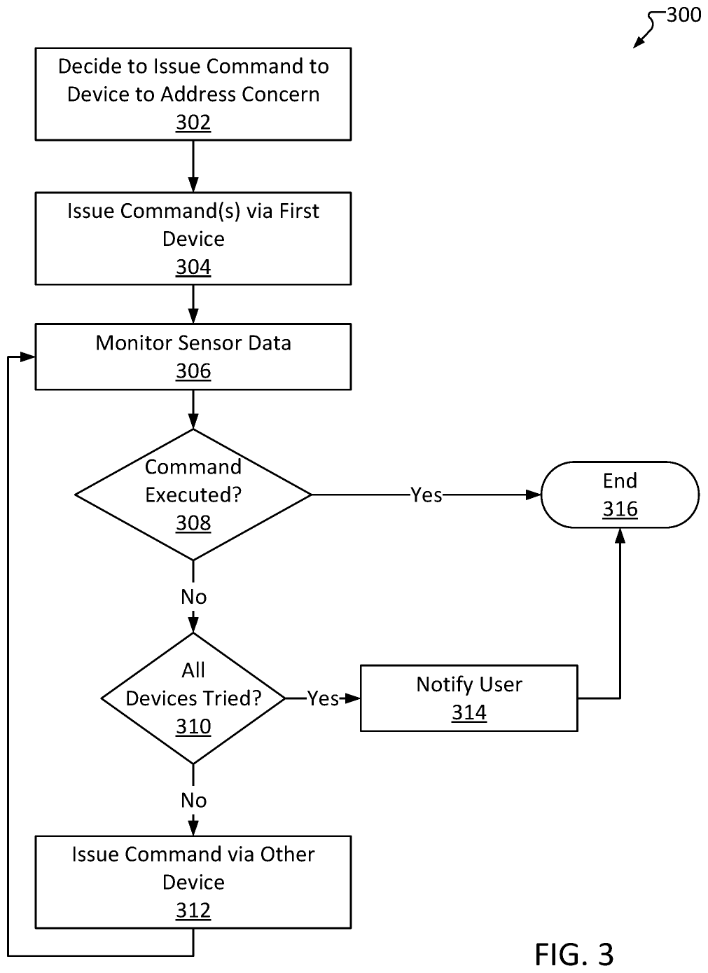

FIG. 3 is a method 300 of issuing commands via multiple devices in a mesh network, consistent with several embodiments of the present disclosure. In some instances, method 300 may function as an example implementation of operation 112 of method 100.

Method 300 comprises deciding to issue a command to a device at operation 302 to address a concern. Operation 302 may include, for example, determining that a device activation with a high confidence-adjusted risk has occurred, such as an activation of an oven that is determined to be likely unintentional, and determining to send a deactivation command (e.g., a “kill switch” command) to the oven. Operation 302 may be performed in a manner substantially similar to operations 102-108 of method 100, as discussed above with reference to FIG. 1. Method 300 further comprises issuing the decided-upon command via a first device at operation 304. Operation 304 may include, for example, causing a first smart device in an IoT network to transmit the command to the target device. As an illustrative example, operation 304 may include a mesh network of devices causing a smart microwave oven to issue a shutdown instruction to a smart conventional oven. The first device may be selected based on, for example, proximity (known or estimated) to the target device, strength of a signal between the devices, etc.

Method 300 further comprises monitoring sensor data at operation 306. Operation 306 may include, for example, receiving data from sensors of various devices in a mesh network. In some instances, operation 306 may include, for each device of the network, monitoring data from its own sensors only.

Method 300 further comprises determining whether the command has been executed at operation 308. Operation 308 may include, for example, comparing the sensor data monitored at operation 306 to a knowledgebase in order to determine whether a target device has executed the command issued at operation 304. As an illustrative example, operation 302 may include determining to deactivate an oven, operation 304 may include transmitting a “deactivate” instruction to the oven via a nearby microwave oven, operation 306 may include monitoring thermometer data, and operation 308 may include determining, based on comparing the thermometer data to expected temperatures stored in the knowledgebase, whether the oven has deactivated. If the command has been executed (308 “Yes”), method 300 ends at 316. If the command has not been executed (308 “No”), method 300 further comprises determining whether all devices in the network have attempted to issue the command to the target device at operation 310. Note that, in some instances, operation 308 may include a waiting period; for example, if the command is to deactivate an oven, the temperature may not noticeably drop for several minutes, in which case operation 308 may include waiting for several minutes before determining whether the temperature has dropped as expected.

Operation 310 may include, for example, checking (and maintaining) a list of devices that have sent the command to the target device. If one or more devices in the mesh network have not yet attempted to transmit the command (310 “No”), method 300 further comprises issuing the command to the target device via one or more other devices at operation 312. For example, if a microwave oven sends a command to an oven but the command does not appear to have been executed, a system performing method 300 may cause a smart lightbulb to send the same command to the oven. Method 300 may then return to monitoring sensor data at 306 to determine whether the command has been executed at operation 308.

In some instances, operation 312 may include causing all devices (possibly including those that have already tried) to attempt to issue the command to the target device. This may advantageously save time, particularly if operation 308 requires waiting for a set period before determining whether the command has been executed. For example, if a microwave oven sends a shutdown command to an oven but the temperature continues to increase, a system may cause all devices in the network (including the microwave oven) to send the shutdown command to the oven. This way, the system is able to determine whether it is capable of causing the command to be executed without having to wait for a set time for each device in the network.

If the command has not been executed (308 “No”) and all devices have been tried (310 “Yes”), method 300 further comprises notifying a user at operation 314. Operation 314 may include, for example, indicating to the user that the target device has not executed the command. Operation 314 may further include contextual information, such as what command should be executed, why the command has been selected, possible reasons that the command has not been executed, etc. For example, operation 314 may include sending a text message to a user's mobile device reading “Your oven has been detected to be heating up. We tried to shut it down, but it looks like we were unable to. Please check the oven and, if necessary, turn it off manually.” Method 300 may then end at 316.

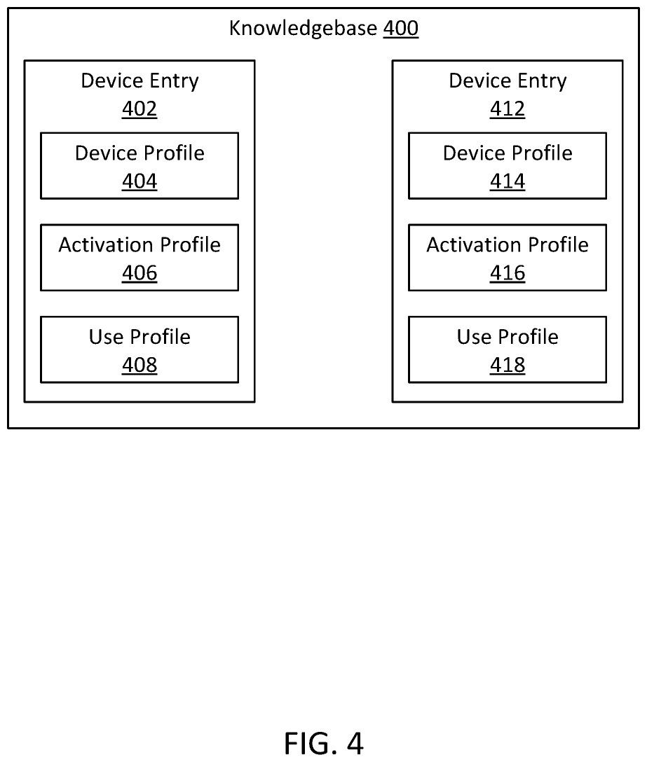

FIG. 4 is a diagram of an example knowledgebase 400 including entries for multiple devices in an IoT mesh network, consistent with several embodiments of the present disclosure. Knowledgebase 400 includes information about a first device in device entry 402 as well as information about a second device in device entry 412. Each device includes a device profile, an activation profile, and a use profile. For example, device entry 402, which may be, for example, information about a microwave oven, has a device profile 404, activation profile 406, and use profile 408. Similarly, device entry 412, which may be, for example, information about an industrial grinder machine, has device profile 414, activation profile 416, and use profile 418.

In essence, device profiles include information that can be utilized to identify a device as well as determine a risk associated with the device. Activation profiles include information that can be utilized to determine whether the device has actually been activated or not. Use profiles include information that can be utilized to determine whether a detected activation is likely intentional. In combination, knowledgebase 400 enables systems and methods consistent with the present disclosure to calculate confidence-adjusted risk scores of detected activations.

Device profiles include information about the device itself. For example, device profile 404 may include a type of the first device and an identifier (e.g., “microwave oven #1”). Device profile 404 may also include a make and model of the first device (e.g., Acme Microwave, model MW-A7S). In some instances, device profile 404 may also include a location of the device, such as a room designation (e.g., “Kitchen”), Global Positioning System (GPS) coordinates, etc. In some instances, device profile 404 may also include capabilities of the device, such as, for example, sensors (e.g., thermometer, microphone), connectivity (e.g., Wi-Fi, Near-Field Communication (NFC)), as well as devices that the device can communicate with (e.g., refrigerator, light bulbs 7-13 (not shown in FIG. 4), etc.). Some of this information may be set by a manufacturer of the first device. In some instances, device profile 404 may be entered by a user. In some instances, device profile 404 can be automatically updated, particularly with regards to devices that the first device is in communication with (such as when new devices are added, when devices are moved, when updates enable additional connectivity, etc.).

Device profile 404 may also include safety and other risk-related information. For example, device profile 404 may indicate that the first device has a minor (but non-trivial/nonzero) risk of fire, a negligible risk of physical injury, consumes 1000 W while in use, etc. In contrast, device profile 414 may indicate that the second device, as an industrial manufacturing component, has a negligible risk of fire but a significant risk of physical injury.

Activation profiles include information describing circumstances associated with activation of the device. For example, activation profile 406 may indicate that, upon being activated, the first device may make certain sounds (e.g., a distinctive beep, followed by a hum, eventually followed by a different beep), emit light, etc. In some instances, activation profile 406 may further include power consumption associated with use (this information can be stored in activation profile 406, device profile 404, both, or neither). In some instances, activation profile 406 may include historical sensor data associated with confirmed activations of the first device. For example, activation profile 406 may indicate that, on a first confirmed instance of the first device being activated, device 404's microphone recorded a beeping sound, and that device 404's thermometer did not record any temperature change relative to before the activation.

Use profiles may include information describing usage patterns of the device. For example, use profile 408 may list previous activations of the first device, along with surrounding information. As an example, use profile 408 may indicate that, for every recorded activation of the first device, a first user was present in the home and, for 75% of the recorded activations of the first device, a second user was not present in the home. As an additional example, use profile 408 may indicate that the first device is always activated “manually” (e.g., a user has never utilized a remote activation feature; use profile 408 may further indicate whether or not the first device has remote activation capabilities). As another example, use profile 408 may further indicate that the first device is rarely activated between the hours of 4 AM and 9 AM, but is frequently activated on Monday through Friday evenings.

Use profiles may also describe how usage patterns of the device correlate to use of other devices. For example, device profile 404 may indicate that most activations of the first device occur shortly after a smart refrigerator has been opened and closed. Thus, a system may detect activation of the first device that does not occur shortly after the smart refrigerator has been opened and closed, and conclude that the activation is more likely to be unintentional.

Additional devices (not shown in FIG. 4) are also supported. For example, knowledgebase 400 may include information for every device in a mesh network. In some instances, knowledgebase 400 may further include information for devices that are not in the mesh network, such as a door, a faucet, etc. This may further enable tracking correlations between device activations; for example, a faucet may have an activation profile and use profile that enable determining when the faucet is activated. Activation of one of the devices in the mesh network may be correlated (or anticorrelated) with activation of the faucet, so even though the faucet may not be a member of the mesh network, the network may benefit from information helping it determine when it has been activated.

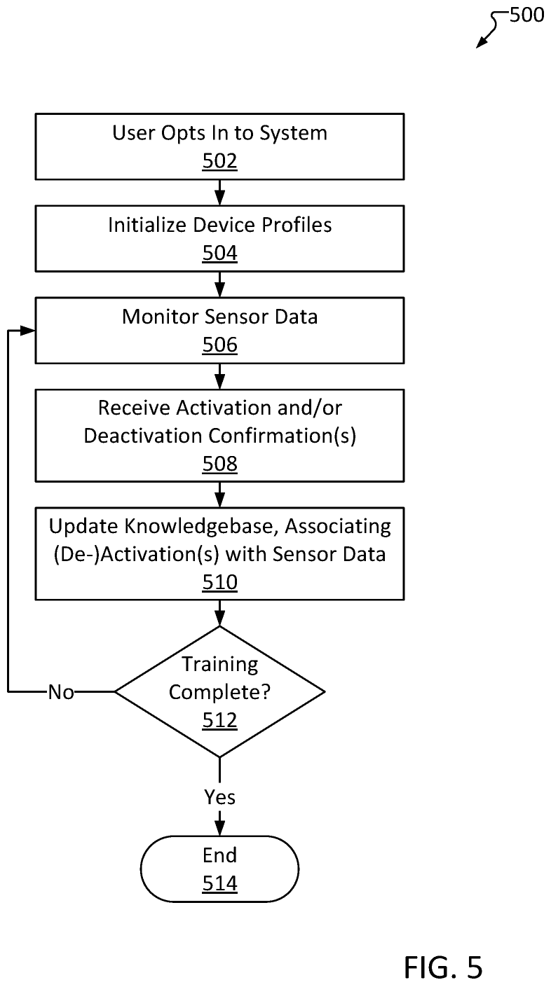

FIG. 5 is a method 500 for initial configuration and training of a mesh network implementing correlative risk management, consistent with several embodiments of the present disclosure. The system trained via method 500 may include, for example, a supervised-learning neural network engine. Method 500 comprises opting into the system at operation 502. Operation 502 may include, for example, presenting, to a user of an IoT mesh network of smart devices, an option to opt into correlative risk management consistent with the present disclosure. The user may be required to proactively opt in before monitoring begins, and may be provided the option to opt out at any time.

Method 500 further comprises initializing device profiles at operation 504. Operation 504 may include, for example, receiving input from the user describing different devices on the IoT mesh network. In some instances, device profiles may be populated automatically based on manufacturer information; for example, devices in the mesh network may communicate with one another to establish a knowledgebase including device information. In some instances, operation 504 may include receiving, from a user, location information for one or more devices in the network.

Method 500 further comprises monitoring sensor data at operation 506. Operation 506 may include, for example, monitoring feeds from different sensors included in devices in the network. For example, a smart thermostat with a thermometer and a microphone may monitor temperature and sound levels, while a refrigerator with a camera may monitor a video feed from the camera. The sensor feeds monitored via operation 506 may be associated with device activations and/or deactivations, as described in further detail below.

Method 500 further comprises receiving activation and/or deactivation confirmation(s) at operation 508. Operation 508 may include, for example, receiving an input from a user via a user interface (UI) enabled through a smartphone application. As an illustrative example, in initializing the system, a user may be asked to input feedback when the user activates and/or deactivates certain devices, in order to help train the system and develop the knowledgebase. At first, the user may need to manually create entries (e.g., the user may indicate that the oven was activated at 3:13 PM and deactivated at 4:08 PM). However, as the system learns (but is still in training), operation 508 may include prompting the user, such as pushing a notification asking: “Did you just turn your oven on?”

Method 500 further comprises updating a knowledgebase at operation 510. The updates to the knowledgebase may associate the activations and/or deactivations confirmed at operation 510 with the sensor data being monitored at operation 506. For example, a user input may be received at operation 510 confirming that an oven was activated at 5:07 PM. Sensor data monitored via operation 506 may indicate that a temperature recorded at a refrigerator was 74° F. at 5:07 PM and increased to 78° F. by 5:27 PM. Operation 510 may include adding an entry to an activation profile of the oven indicating that the refrigerator's thermometer registered a 4° F. increase in temperature over 20 minutes upon activation of the oven. This way, in the future, if the refrigerator thermometer reads a 4° F. increase in temperature over 20 minutes, the system may have a relatively high confidence that the oven has been activated. As noted above, this can be reinforced by cross-checking with other sensor readouts. For example, activating the oven and activating a dishwasher may both result in the refrigerator's thermometer increasing by 4° F. over 20 minutes, but the dishwasher may also emit sound that can be recorded by a thermostat. Thus, if the refrigerator thermometer reads a 4° F. increase in temperature over 20 minutes but no sound is heard, the system can conclude that the oven has been activated. In contrast, if the refrigerator thermometer reads a 4° F. increase in temperature over 20 minutes and a sound (consistent with the dishwasher) is detected by the thermostat, the system can determine that the dishwasher has been activated.

Notably, these correlations do not need to be set by a user or preconfigured by a manufacturer; they can be learned automatically over time. This advantageously enables correlating sensor data that may otherwise be unexpected. For example, a downstairs lightbulb may include an accelerometer that may register a characteristic vibration pattern upon activation of the dishwasher. Method 500 may result in automatically learning this relationship without being prompted for it; neither a manufacturer of the light bulb, a manufacturer of the dishwasher, or the user owning both devices may anticipate that the light bulb's accelerometer is useful to determine whether the dishwasher is active. However, by correlating sensor data from each device monitored at operation 506 with activations confirmed via operation 510, systems and methods consistent with the present disclosure can discover correlations between devices that might otherwise not be considered.

Method 500 further comprises determining whether training is complete at operation 512. Operation 512 may include, for example, determining whether a knowledgebase has reached a target size (e.g., 5 confirmed activations for each device in the network). In some instances, operation 512 may include determining whether a detected activation has been correct a target number of times consecutively (e.g., the system may be considered “trained” once it successfully identifies that the oven has been activated 5 times in a row). In some instances, operation 512 may include comparing a prediction to the confirmation received at operation 508. For example, the system may, as part of monitoring sensor data at operation 506, make a prediction regarding whether any devices have been activated. This prediction may then be compared with confirmation received at operation 508. In such instances, operation 512 may include determining an accuracy of the prediction. Training may be complete once accuracy reaches a threshold (e.g., 98%) and maintains the threshold for a preset time or number of predictions.

If training is incomplete (512 “No”), method 500 returns to monitoring sensor data at operation 506. Operations 506-512 may be repeated until training is complete. Once training is complete (512 “Yes”), method 500 ends at 514.

In addition to detecting activations of various devices, method 500 can also train a system to identify deactivations. For example, sensor data may be correlated with turning an oven off, allowing a system trained via method 500 to notify a user if an oven was deactivated seemingly unintentionally.

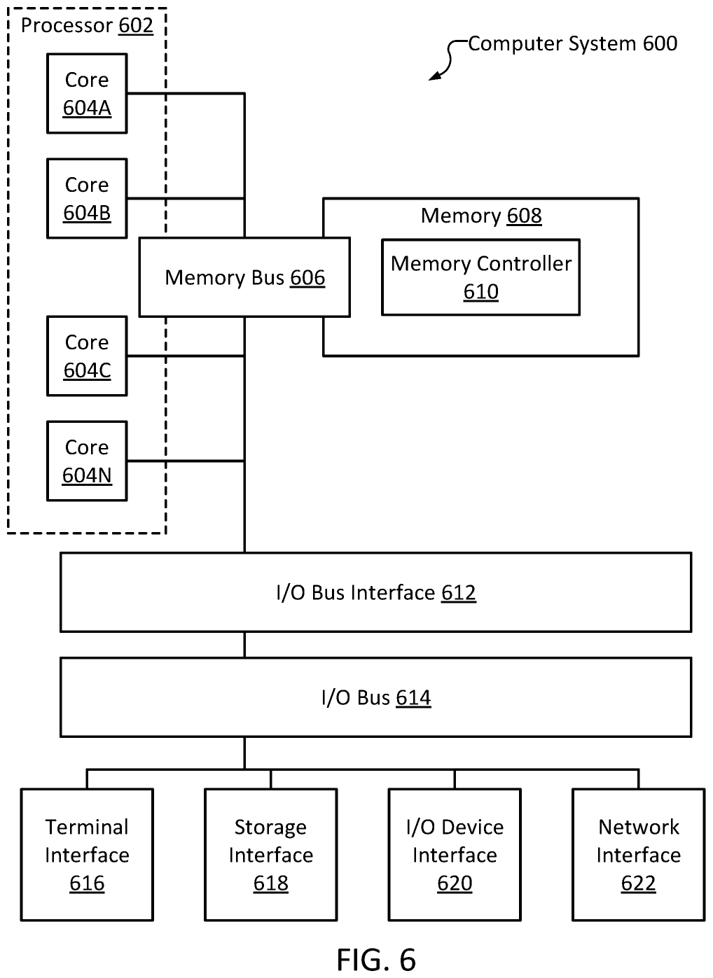

Referring now to FIG. 6, shown is a high-level block diagram of an example computer system 600 that may be configured to perform various aspects of the present disclosure, including, for example, methods 100, 300, and 500. The example computer system 600 may be used in implementing one or more of the methods or modules, and any related functions or operations, described herein (e.g., using one or more processor circuits or computer processors of the computer), in accordance with embodiments of the present disclosure. In some embodiments, the major components of the computer system 600 may comprise one or more CPUs 602, a memory subsystem 608, a terminal interface 616, a storage interface 618, an I/O (Input/Output) device interface 620, and a network interface 622, all of which may be communicatively coupled, directly or indirectly, for inter-component communication via a memory bus 606, an I/O bus 614, and an I/O bus interface unit 612.

The computer system 600 may contain one or more general-purpose programmable processors 602 (such as central processing units (CPUs)), some or all of which may include one or more cores 604A, 604B, 604C, and 604N, herein generically referred to as the CPU 602. In some embodiments, the computer system 600 may contain multiple processors typical of a relatively large system; however, in other embodiments the computer system 600 may alternatively be a single CPU system. Each CPU 602 may execute instructions stored in the memory subsystem 608 on a CPU core 604 and may comprise one or more levels of on-board cache.

In some embodiments, the memory subsystem 608 may comprise a random-access semiconductor memory, storage device, or storage medium (either volatile or non-volatile) for storing data and programs. In some embodiments, the memory subsystem 608 may represent the entire virtual memory of the computer system 600 and may also include the virtual memory of other computer systems coupled to the computer system 600 or connected via a network. The memory subsystem 608 may be conceptually a single monolithic entity, but, in some embodiments, the memory subsystem 608 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 608 may contain elements for control and flow of memory used by the CPU 602. This may include a memory controller 610.

Although the memory bus 606 is shown in FIG. 6 as a single bus structure providing a direct communication path among the CPU 602, the memory subsystem 608, and the I/O bus interface 612, the memory bus 606 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 612 and the I/O bus 614 are shown as single respective units, the computer system 600 may, in some embodiments, contain multiple I/O bus interface units 612, multiple I/O buses 614, or both. Further, while multiple I/O interface units are shown, which separate the I/O bus 614 from various communications paths running to the various I/O devices, in other embodiments some or all of the I/O devices may be connected directly to one or more system I/O buses.

In some embodiments, the computer system 600 may be a multi-user mainframe computer system, a single-user system, or a server computer or similar device that has little or no direct user interface but receives requests from other computer systems (clients). Further, in some embodiments, the computer system 600 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative major components of an exemplary computer system 600. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A method, comprising:
monitoring sensor data;
comparing the sensor data to an activation profile in a knowledgebase;
detecting, based on the comparing, an activation of a first device in a network;
calculating an activation confidence score of the activation, the calculating based on a use profile in the knowledgebase;
calculating a risk of the activation, the risk based on a device profile in the knowledgebase;
calculating a confidence-adjusted risk score based on the activation confidence score and the risk;
determining that the confidence-adjusted risk score is above a risk threshold;
issuing, by a second device in the network and in response to the determining, a command to the first device;
determining that the command is not executed by the first device; and
issuing, by a third device in the network and in response to the determining that the command is not executed by the first device, the command to the first device.

2. (canceled)

3. The method of claim 1, further comprising:
receiving feedback from a user; and
updating the knowledgebase based on the feedback.

4. The method of claim 3, further comprising transmitting a notification to the user, wherein the feedback is received in response to the notification.

5. The method of claim 1, wherein the command is a deactivation command.

6. The method of claim 1, further comprising training a supervised-learning neural network mesh network, the training including:
initializing device profiles for each of a plurality of devices in the mesh network, the plurality of devices including the first device and the second device;
monitoring sensor data from the plurality of devices;
receiving a confirmation of an activation of the first device; and
updating, based on the confirmation, the activation profile to include the sensor data.

7. The method of claim 1, wherein the network is a mesh network.

8. A system, comprising:
a memory; and
a central processing unit (CPU) coupled to the memory, the CPU configured to:
monitor sensor data;
compare the sensor data to an activation profile in a knowledgebase;
detect, based on the comparing, an activation of a first device in a network;
calculate an activation confidence score of the activation, the calculating based on a use profile in the knowledgebase;
calculate a risk of the activation, the risk based on a device profile in the knowledgebase;
calculate a confidence-adjusted risk score based on the activation confidence score and the risk;
determine that the confidence-adjusted risk score is above a risk threshold;
issue, by a second device in the network and in response to the determining, a command to the first device;
determine that the command is not executed by the first device; and
issue, by a third device in the network and in response to the determining that the command is not executed by the first device, the command to the first device.

9. (canceled)

10. The system of claim 8, wherein the CPU is further configured to:
receive feedback from a user; and
update the knowledgebase based on the feedback.

11. The system of claim 10, wherein the CPU is further configured to transmit a notification to the user, wherein the feedback is received in response to the notification.

12. The system of claim 8, wherein the command is a deactivation command.

13. The system of claim 8, wherein the CPU is further configured to train a supervised-learning neural network mesh network, the training including:
initializing device profiles for each of a plurality of devices in the mesh network, the plurality of devices including the first device and the second device;
monitoring sensor data from the plurality of devices;
receiving a confirmation of an activation of the first device; and
updating, based on the confirmation, the activation profile to include the sensor data.

14. The system of claim 8, wherein the network is a mesh network.

15. A computer program product, the computer program product comprising a computer readable storage medium having program instructions embodied therewith, the program instructions executable by a computer to cause the computer to:
monitor sensor data;
compare the sensor data to an activation profile in a knowledgebase;
detect, based on the comparing, an activation of a first device in a network;
calculate an activation confidence score of the activation, the calculating based on a use profile in the knowledgebase;
calculate a risk of the activation, the risk based on a device profile in the knowledgebase;
calculate a confidence-adjusted risk score based on the activation confidence score and the risk;
determine that the confidence-adjusted risk score is above a risk threshold;
issue, by a second device in the network and in response to the determining, a command to the first device;
determine that the command is not executed by the first device; and
issue, by a third device in the network and in response to the determining that the command is not executed by the first device, the command to the first device.

16. (canceled)

17. The computer program product of claim 15, wherein the instructions further cause the computer to:
receive feedback from a user; and
update the knowledgebase based on the feedback.

18. The computer program product of claim 17, wherein the instructions further cause the computer to transmit a notification to the user, wherein the feedback is received in response to the notification.

19. The computer program product of claim 15, wherein the command is a deactivation command.

20. The computer program product of claim 15, wherein the instructions further cause the computer to train a supervised-learning neural network mesh network, the training including:
initializing device profiles for each of a plurality of devices in the mesh network, the plurality of devices including the first device and the second device;
monitoring sensor data from the plurality of devices;
receiving a confirmation of an activation of the first device; and
updating, based on the confirmation, the activation profile to include the sensor data.
